(19) United States
(12) Patent Application Publication
(10) Pub. No.: US 2007/0138006 A1
(43) Pub. Date: Jun. 21, 2007

(54) System and Method for Generating Hydrogen Gas

(76) Inventors: Thomas W. Oakes, La Mesa, CA (US); Robert E. Oakes, El Cajon, CA (US)

Correspondence Address: WILLIAM J. KOLEGRAFF, 3119 TURNBERRY WAY, JAMUL, CA, 91935, US

(21) Appl. No.: 11/612,613

(22) Filed: Dec. 19, 2006

Related U.S. Application Data
(60) Provisional application No. 60/751,903, filed on Dec. 21, 2005.

(51) Int. Cl. C25B 9/00; B60L 11/18; H01M 8/18

(52) U.S. Cl. 204/278; 204/266; 180/65.3; 429/21

(57) ABSTRACT

A hydrogen gas generation system is provided for use in a mobile vehicle. The mobile vehicle may be for example, a car or truck or other vehicle such as a balloon, dirigible, airship, ship, or boat. The vehicle has an on-board hydrogen generator for generating hydrogen gas, preferably using an electrolysis process. The hydrogen produced by the electrolysis process is stored in an on-board hydrogen storage tank. Hydrogen from the storage tank is flowed into a vehicle propulsion system where the hydrogen gas is consumed to provide power to propel the vehicle. An on-board electrical generation system provides at least some of the electricity for the electrolysis process. In one example, the vehicle has an on-board electrical generator for providing electricity for the electrolysis process. The on-board electric generation system may be, for example, a solar photovoltaic cell system, a wind turbine generator system, or a regenerative braking generator, for example. Depending on the particular electrical generation process or processes used, the vehicle may generate hydrogen gas when moving, when coasting or braking, or when long-term parked.

### RELATED APPLICATIONS

This application claims priority to U.S. patent application No. 60/751,903, filed Dec. 21, 2005, and entitled “System and Method for Portable Onboard Vehicle Hydrogen Gas Generation Using Vehicle Kinetic Energy and Renewable Energy”; and is related to U.S. patent application Ser. No. 10/785,234, filed Feb. 24, 2004, and entitled “System and Method for Generating Hydrogen Gas Using Renewable Energy”; both of which are incorporated herein in their entirety.

### BACKGROUND

1. Field

The field of the present invention is hydrogen generation. More particularly, the present invention relates to the generation of a hydrogen gas for mobile, vehicle, or portable applications.

2. Discussion of Prior Art

Hydrogen gas shows great promise as a fuel for powering mobile vehicles such as cars and trucks. Hydrogen burns cleanly, and may be produced using renewable energy sources. Accordingly, it has the potential for reducing greenhouse gas emissions and pollutants, and reducing dependency on carbon-based fuels for motor vehicles. Typically, for vehicular use, hydrogen gas is pumped into a high pressure tank on the vehicle at a fueling station. The high-pressure tank, which typically may operate at 5,000-10,000 psi (pounds per square inch), flows fuel into a power plant for propelling the vehicle. The power plant may be a combustion engine that directly burns the hydrogen gas, or may have a fuel cell that generates electrical power for driving one or more electric drive motors. Either way, the stored hydrogen gas is consumed from the high-pressure tank to produce propulsion energy.

Adoption of hydrogen-powered vehicles has been slowed, in part, by the need to provide a sufficient density of hydrogen refueling stations. Unfortunately, hydrogen vehicles typically have a shorter range than a comparable carbon-fuel vehicle, so may require more refueling stations as compared to regular gas or diesel vehicles. Also, an entire distribution system needs to be built, which entails generation plants, pipelines, storage tank farms, distribution fleets, station storage tanks, and vehicle delivery pumps. The new infrastructure to support hydrogen distribution represents a massive construction undertaking, will take years to build-out, and has an associated staggering cost. However, until the hydrogen refueling issue is addressed, hydrogen-powered vehicles will not gain widespread use.

Full hydrogen powered vehicles are available today from a number of both domestic and foreign manufacturers. Across the nation there are a very limited number of filling stations where hydrogen may be purchased for drive up vehicles. In 2006 two stations are available in Washington, D.C. area, some in the New York City area, two in San Diego, Calif., and only 27 such stations are now available in the Los Angels, Calif. area. With so few hydrogen stations available, any user of a hydrogen vehicle has very limited range and destination options.

Hydrogen production has been primarily carried out by large refineries using oil or natural gas as feed stock for using steam conversion. Some hydrogen manufacturing uses utility-produced electricity for causing an electrochemical reaction. Certain hydrogen producing approaches have proposed a solar assist with utility electricity, or solar-exposed opposing glass sheets with electrically conducting coatings. However, no practical way is known to generate hydrogen on-site for individual and commercial needs, exclusively by renewable energy sources, with no fossil fuel consumption or pollution. These current hydrogen-generation facilities are typically large central facilities that still require a pipeline or truck distribution to individual re-fueling stations.

The problems of previous efforts of producing hydrogen include high capital expenditures, fossil fuel consumption, pollution, low production, low efficiency, non-durable equipment, long distance energy transmission, and they do not make distributed energy on-site. Copending U.S. patent application Ser. No. 10/785,234, filed Feb. 24, 2004, and entitled “System and Method for Generating Hydrogen Gas Using Renewable Energy”, discloses a hydrogen generator that is capable of localized generation of hydrogen gas using only renewable energy. The hydrogen generator uses a vessel for holding an electrolyte solution. A membrane is arranged in the vessel to form a chamber, and a cathode electrode is positioned in the chamber and in the electrolyte solution. An electric current is applied to the cathode, and with a cooperating anode, produces hydrogen gas using an electrolysis process. The membrane traps or confines the hydrogen in an open area of the chamber, and assists in keeping the hydrogen separate from oxygen or other gasses. The hydrogen gas is exhausted from the chamber for further processing, storage, or use.

In one specific example, the hydrogen generator has a transparent cover and has a photovoltaic panel in the vessel. The photovoltaic panel generates the electricity for powering the electrolysis process. The photovoltaic panel may be submerged in the electrolyte solution, which acts to concentrate light rays onto the panel. Other structures, such as the cover, may be configured to further concentrate light rays onto the panel. In some examples, oxygen gas may also be collected, stored, and used. The generation system may also use an external electricity source for powering the electrolysis process when insufficient electricity is produced by the internal photovoltaic cell. The external power is preferably a renewable source, such as solar, wind, or hydro. In another example, the photovoltaic cells may be positioned away from the main body of the hydrogen generator.

Advantageously, the hydrogen generator may be configured to generate hydrogen gas using renewable sources of energy. Further, the generation system is deployable in a contained vessel, and provides a simple membrane structure for keeping the hydrogen gas separated from the oxygen and from other contaminates. Although such a hydrogen generator desirably generates hydrogen from renewable sources, and may be sized to provide hydrogen generation at home or at a refueling station, there still exists a need to enable the widespread deployment of hydrogen vehicles with a reduced dependency on static refueling stations.

### SUMMARY

Briefly the present invention provides a hydrogen gas generation system for use in a mobile vehicle. The mobile vehicle may be for example, a car or truck or other vehicle such as a balloon, dirigible, airship, ship, or boat. The vehicle has an on-board hydrogen generator for generating hydrogen gas, preferably using an electrolysis process. The hydrogen produced by the electrolysis process is stored in an on-board hydrogen storage tank. Hydrogen from the storage tank is flowed into a vehicle propulsion system where the hydrogen gas is consumed to provide power to propel the vehicle. An on-board electrical generation system provides at least some of the electricity for the electrolysis process. In one example, the vehicle has an on-board electrical generator for providing electricity for the electrolysis process. The on-board electric generation system may be, for example, a solar photovoltaic cell system, a wind turbine generator system, or a regenerative braking generator, for example. Depending on the particular electrical generation process or processes used, the vehicle may generate hydrogen gas when moving, when coasting or braking, or when long-term parked.

In a preferred example, a hydrogen gas generation system is provided on a mobile vehicle such as a car or truck. The hydrogen gas generation system uses an electrolysis process, and traps hydrogen gas using a membrane system. Hydrogen generated by the electrolysis process is pumped to a low pressure storage tank, where the gas may be selectively flowed to a vehicle propulsion system. The vehicle propulsion system may be a fuel cell for generating electricity for drive motors, or may be a combustion engine that consumes hydrogen gas. An on-board electrical generator is used to generate electricity for use by the electrolysis process. Electricity from the on-board generator system may be stored in a battery system, or may be directly used. The on-board generator may take the form of solar photovoltaic cells, a wind turbine generator, or a regenerative braking system. In some examples, a reserve hydrogen tank may be provided for when the low pressure hydrogen tank is depleted or low.

Advantageously, the present invention enables a hydrogen vehicle to operate on hydrogen gas with a reduced dependency on refueling. More particularly, the present invention enables the vehicle to utilize renewable sources of energy or regenerative energy for generating hydrogen gas for consumption in the vehicle's propulsion system. In some cases, both regenerative and renewable generation processes may be used. By enabling the use of hydrogen vehicles with reduced dependence of on refueling stations, the use and adoption of hydrogen vehicle systems may be accelerated. In this way, the use of carbon-based fuels, the emission of greenhouse gases, and dependency on unstable sources of energy may all be reduced.

### BRIEF DESCRIPTION OF THE DRAWINGS

FIG. 1 is a block diagram of a hydrogen powered vehicle having a generation system in accordance with the present invention.

FIG. 2 is a block diagram of a hydrogen generation system in accordance with the present invention.

FIG. 3 is a block diagram of a hydrogen generation system in accordance with the present invention.

FIG. 4 is a block diagram of a hydrogen generator in accordance with the present invention.

FIG. 5 is a block diagram of a low pressure main hydrogen tank for use with a hydrogen generation system in accordance with the present invention.

FIG. 6 is a block diagram of a high pressure reserve hydrogen tank for use with a hydrogen generation system in accordance with the present invention.

FIG. 7 is a diagram of a wind turbine generator in accordance with the present invention.

FIG. 8 is a flow chart of a method of using of a hydrogen generation system to power a hydrogen vehicle in accordance with the present invention.

FIG. 9 is a flow chart of a method of using of a hydrogen generation system to power a hydrogen vehicle in accordance with the present invention.

FIG. 10 is a block diagram of a hydrogen generation system in accordance with the present invention.

FIG. 11 is a block diagram of a hydrogen generation system in accordance with the present invention.

FIG. 12 is a flow chart of a method of using of a hydrogen generation system to power a refrigeration unit in accordance with the present invention.

FIG. 13 is a diagram of hydrogen regeneration processes and structures in accordance with the present invention.

FIG. 14 is a diagram of a wind turbine generator in accordance with the present invention.

FIG. 15 is a diagram of a wind turbine generator in accordance with the present invention.

### DETAILED DESCRIPTION

An active system and method is described for generating hydrogen gas on a motor vehicle itself, to be used as motive energy for vehicles. The system may employ multiple sources of on-board kinetic and renewable energy for onboard generation. The methods may include 1) capture of kinetic energy from the vehicle regenerative braking wheel system, 2) using air flow of the moving vehicle against fan blades on electrical generators as additional regenerative braking; 3) on-board generation using solar photovoltaic cells. The high peak electrical output generating methods such as braking, are used to generate electricity to be stored in electricity storage including batteries, capacitors, or spinning fly wheel, so that such electricity may be controlled and directed into an on-board low voltage direct photoelectrochemical hydrogen generator to disassociate water into hydrogen and oxygen. These onboard vehicle kinetic or renewable energy sources provide electrical current in a suitable configuration to disassociate or split water into hydrogen and oxygen in a photoelectrochemical hydrogen generator. The present system and method also includes a reserve storage tank for hydrogen to be supplied by outside stationary filling station, which provides the vehicle with an additional source of energy from an outside free-standing reserve source. The hydrogen is them consumed by a vehicle propulsion system for powering the vehicle.

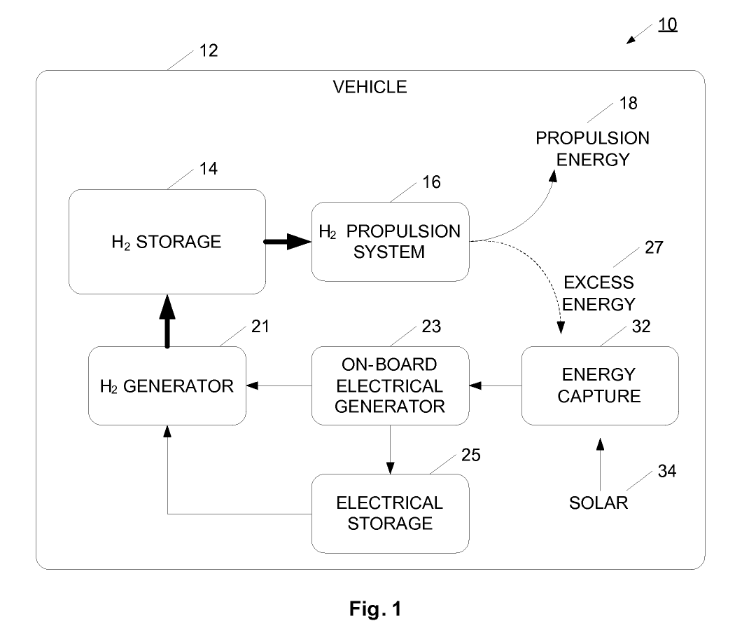

Referring now to FIG. 1, a vehicle power system 10 is illustrated. System 10 is preferably mounted in or on a vehicle 12. The vehicle 12 may be, for example, a car, truck, or other motorized vehicle. For example, the vehicle may be an airship, balloon, dirigible, ship, or boat. Although hydrogen is anticipated to be the primary or only propulsion fuel for the vehicle, it will be appreciated that the power system may be used as an assist or to supplement another type of fuel source. The vehicle 12 may be powered by a combustion type engine, or may be driven using electric motors. Vehicle 12 has a hydrogen storage system 14 for locally storing hydrogen gas. Hydrogen storage tank 14 may include one or more tanks, and the tanks may operate at varying levels of pressure. It will also be understood that the size, type, and pressure in the storage system may be adjusted according to specific needs of the vehicle, including the type of propulsion system used, and the desired operating conditions and range. The vehicle 12 also includes a propulsion system 16. In one example, the propulsion system 16 includes a fuel cell that consumes hydrogen gas and generates an electric current. The electric current may then be used to drive one or more electric drive motors on the vehicle. In another example, the propulsion system 16 may be a combustion engine which burns hydrogen gas and creates mechanical drive energy for driving a drive chain. Accordingly, the propulsion system 16 generates a propulsion energy 18 that is used for moving the vehicle in a desired direction.

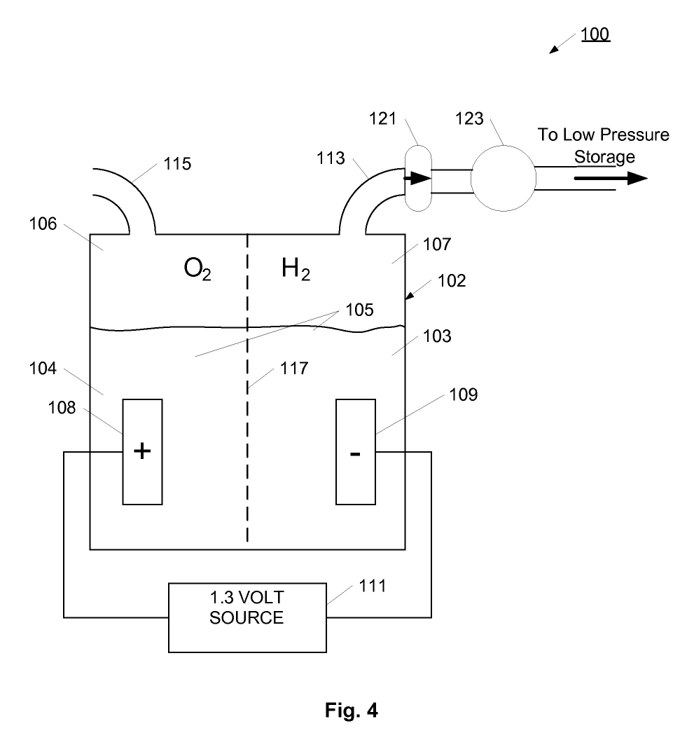

Vehicle 12 also has an on-board hydrogen generator 21. The hydrogen generator 21 may be a hydrogen generator as described with reference to FIG. 4. Generally, hydrogen generator 21 is a self-contained hydrogen generation unit having a membrane for automatically trapping and separating hydrogen gas responsive to an electrolysis process. The electrolysis process may be driven by an electric current supplied by an electrical storage system 25, which may be, for example, a battery. An on-board electrical generator 23 may be provided for powering the hydrogen generator 21, or for recharging power in the electrical storage 25. The on-board electrical generator may take the form of a solar energy conversion process where solar energy 34 is received into photovoltaic cells 32 for producing electricity. In another example, the on-board electric generator may be a regenerative braking system or wind turbine that captures kinetic energy 32 from the vehicle when the vehicle is being propelled with excess energy 27. For example, when the vehicle is braking, excess energy 27 is typically converted by braking pads into heat. To use this excess energy, upon the application of a brake, an air vent may be set to flow air into a wind turbine for generating electricity, or a motor or generator system may be used to generate power from the drive chain. Either way, the conversion of excess kinetic energy into electricity helps conserve overall power usage for the vehicle, as well as assist in the braking process. It will be understood that the energy capture 32 may use an on-board processor or controller for determining when to activate the regenerative braking system or wind turbine.

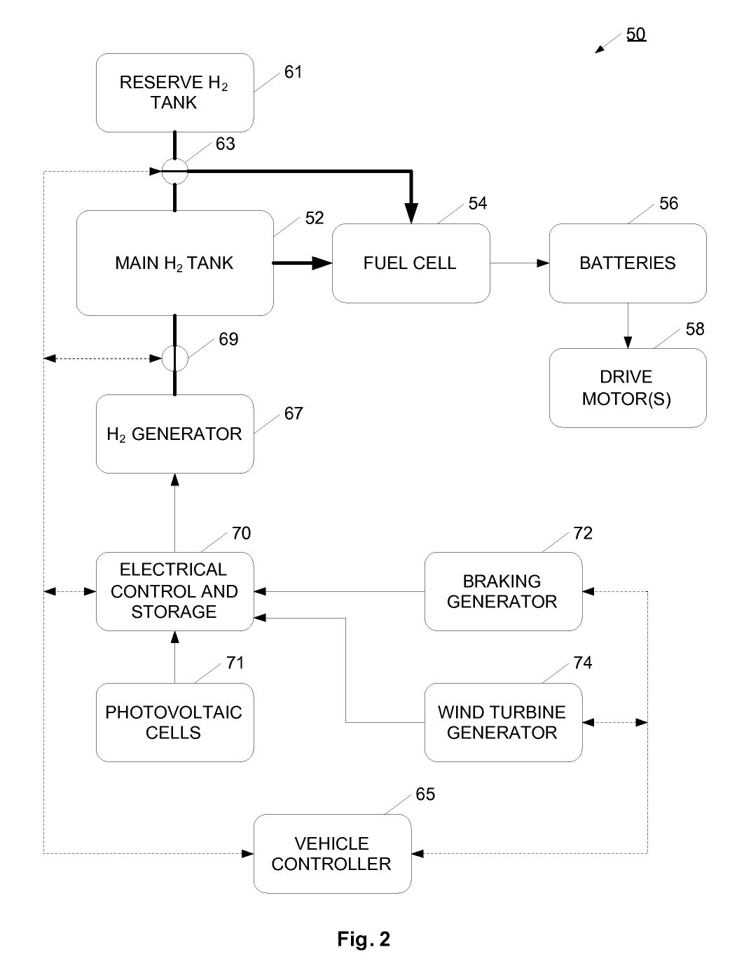

Referring now to FIG. 2, a hydrogen generation system for a vehicle is illustrated. System 50 may be advantageously used on a vehicle such as a car or truck. System 50 includes a reserve hydrogen tank 61 for holding high pressure hydrogen. This high-pressure hydrogen may be received, for example, from a refueling station. Refueling the reserve high-pressure tanks 61 is similar to refueling a vehicle with gas or diesel. Typically, the vehicle is taken to a refueling service station where a high-pressure delivery system is coupled to the reserve tank 61. Several kilograms of hydrogen are transferred into the reserve tank 61, which typically operates at about 5000 psi.

The generation system 50 also includes a main low-pressure hydrogen tank 52. The main tank may operate at a substantially reduced pressure, for example, at or below 200 psi. It will be appreciated that other pressures may be used depending on application specific needs. The main hydrogen tank 52 is the primary source of hydrogen for a fuel cell 54. The fuel cell 54 converts the hydrogen gas into electricity, which may directly drive electric motors or more typically is used to recharge a set of batteries 56. The batteries are then used to power electric motors 58 responsive to a driver's command. However, if the main tank 52 is depleted of hydrogen, a vehicle controller 65 may selectively adjust valve 63 to cause the reserve hydrogen tank 61 to flow hydrogen into fuel cell 54. This may be done by directly flowing hydrogen from the reserve tank 61 to the fuel cell 54, or may be accomplished by replenishing the main tank 52. Either way, the reserve tank 61 is used to power the fuel cell 54 only when the main tank 52 is depleted of hydrogen.

The main tank 52 may also be replenished using an on-board hydrogen generator 67. The hydrogen generator 67 may be, for example, a hydrogen generator as further described with reference to FIG. 4. Hydrogen flowing from the hydrogen generator 67 is pumped into the main hydrogen tanked 52 using pump 69, which enables the lower-pressure gas from the hydrogen generator 67 to be raised to the pressure of the main tank 52. The generator 67 may also have other control systems, check valves, hydration devices, and other components to assist safely flowing hydrogen into the main tank 52. The hydrogen generator 67 is typically an electrolysis-based generator, and thereby requires a steady supply of electrical energy for generating hydrogen gas. Electricity is provided from an electrical control and storage systems 70. The electrical control and storage system 70 may include electronic control devices as well as a battery system. In one example, a set of photovoltaic cells 71 are used to convert solar energy into electricity, which then may be directly used by generator 67 or stored in a battery. These photovoltaic cells would typically be installed on an exposed surface or roof surface of a vehicle to facilitate exposure to the sun. In this way, solar energy is used to drive the hydrogen generator 67.

In another example, a regenerative braking system may be provided which includes a braking generator 72. The braking generator 72 is able to convert excess kinetic energy in the vehicle in to electricity, for example, when the vehicle controller 65 detects that the vehicle is braking or coasting. When the vehicle is braking or coasting, the drive motors may be electrically configured to provide electrical energy to the electrical control and storage systems 70. In another example, a separate alternator or generator may be provided and activated upon detection that the vehicle is braking or coasting. Other types of regenerative braking systems may also be used.

A wind turbine generator 74 may also be mounted in or on the vehicle. The wind turbine generator 74 is mounted in a position to direct an airflow into a wind turbine for driving an electrical generator. Electricity produced in this manner may also be received by the electrical control and storage systems 70 for driving the hydrogen generator 67. In one example, the vehicle controller 65 controls a vent which may selectively direct the airflow into the wind turbine generator 74. In this way, when the vehicle controller detects that excess kinetic energy is available, for example when the vehicle is braking, the vehicle controller may adjust the vent to direct airflow into the turbine. In other cases, for example when the vehicle is accelerating, the vent would be set to more aerodynamically direct the airflow around the vehicle. In yet another example, when the vehicle is parked, the vent may be positioned to allow ambient wind to drive the turbine.

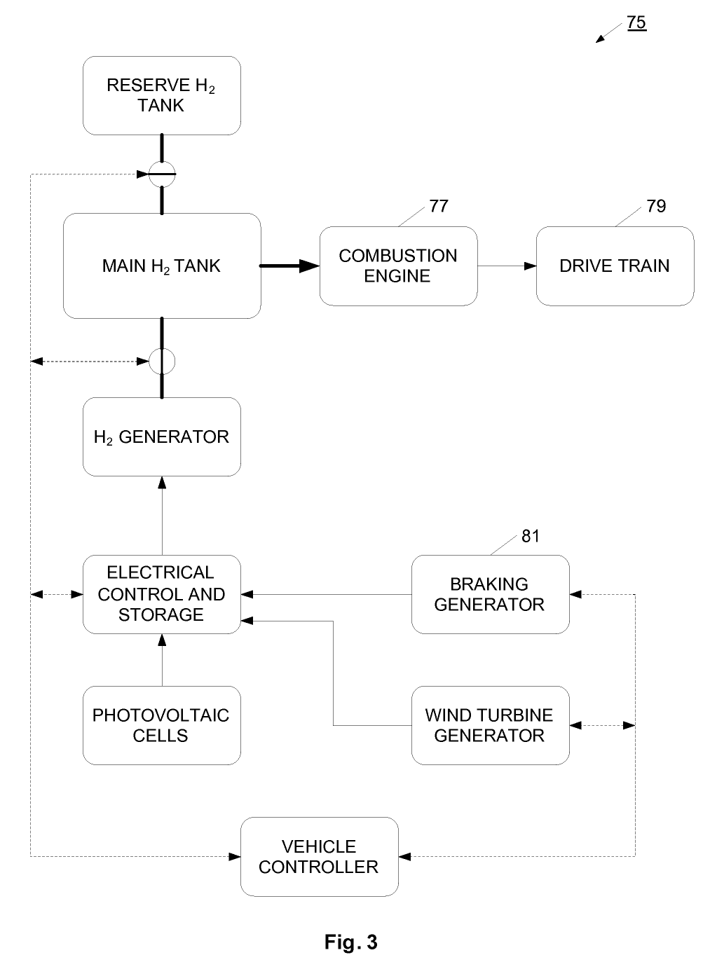

Referring now to FIG. 3, a hydrogen generation system 75 is illustrated. Generation system 75 is similar to generation system 50 described with reference to FIG. 2, so will only be briefly described. Hydrogen generator system 75 is also constructed for use on a mobile vehicle such as a car or truck. System 75 has a reserve tank, main tank, hydrogen generator, and electrical system similar to the systems described with reference to FIG. 2. However, system 75 has a combustion engine 77 which burns hydrogen gas received from the main hydrogen tank. Also, system 75 illustrates that the reserve tank may feed directly into a depleted main tank, although it will be appreciated that the reserve tank may also be used to feed directly into the combustion engine 77. The combustion engine 77 burns hydrogen gas and directly creates mechanical energy for driving a drive train 79. As is well known, the drive train includes power transmission and motion delivery components.

Referring now to FIG. 4, a hydrogen generator 100 is shown. Hydrogen generator 100 may sized and constructed for use on a vehicle, such as a car or truck, or may be constructed for use on other vehicles, such as balloons, dirigible, low and high altitude airships and over the water vessels or boats. The hydrogen generator 100 may be advantageously used in the hydrogen generation systems described with reference to FIGS. 1-3. Generator 100 includes a vessel 102 which holds an electrolyte solution 105. The electrolyte solution 105 may be a mixture of water and an electrolyte, such as an acid or polymeric electrolyte. It will be appreciated that other electrolyte solutions may be used consistent with this disclosure. The vessel has a membrane 117 which is arranged to form a hydrogen chamber 103. A volume space 107 above the electrolyte 105 level enables collection of hydrogen gas. An oxygen chamber 104 may also be formed, and has an associated volume space 106 for collecting oxygen gas. In some cases, the oxygen may be expelled directly to the atmosphere.

Two electrodes are placed in the electrolyte solution 105. A cathode 109 is positioned in the hydrogen chamber 103, and an anode 108 is positioned in the oxygen chamber 104. An electric source 111 is coupled to the cathode 109 and the anode 108, which causes an electrolysis process. More particularly, the electrolysis process splits water molecules into its elements, with hydrogen gas forming at the cathode 109, and oxygen gas forming at the anode 108. The respective gases bubble through the electrolyte solution 105, and the hydrogen case collects in the hydrogen volume 107, while the oxygen gas collects in the oxygen volume 106. A hydrogen outlet 113 is used to exhaust hydrogen gas, and an oxygen outlet 115 is used to exhaust oxygen gas.

The membrane 117 is selected to restrict the passage of the hydrogen gas. In this way, the membrane acts to trap or confine hydrogen gas in the hydrogen collection volume 107. The membrane may also restrict the passage of oxygen, and thereby keeps the hydrogen gas from mixing with oxygen in the oxygen collection volume 106. The membrane may also be selected to facilitate the electrolysis process. For example, the membrane 117 may be a proton-exchange membrane that allows protons to pass during the electrolysis process. It will be appreciated that the composition, characteristics, and dimensions of the membrane may be selected according to specific electrolysis requirements.

An aqueous electrolyte 20 fills the case cavity on both sides of the membrane 24. The electrolyte comprises water and sulfuric acid, for example. In one example the electrolyte is a 10% solution, but other concentrations may be used as needed to control production of hydrogen. Other electrolytes such as polymer composite types may also be employed. Another electrolyte which may be incorporated is a polymer material from Ballard, Burnaby, BC, Canada, which is capable of conducting an electric current in the presence of water, without acid. A preferred membrane 24 may be from 50 microns to 125 microns thick while various thicknesses may be chosen to alter yield of hydrogen and oxygen. This membrane is a product of DuPont Chemical Co of Fayetteville, N.C.

Advantageously, the generation system 101 provides sufficiently pure hydrogen gas without complex gas separation equipment. Instead, the generation system 101 uses a simple membrane to keep the hydrogen separated from other gases, which enables the efficient collection of commercial grade hydrogen gas using known gas-processing techniques. It will be understood that further purifying and processing of the hydrogen gas may be desirable for some uses. Also, the energy source 111 is preferably a renewable electricity source, such as a photovoltaic cell or wind turbine, so the generation system 101 is environmentally friendly, and may be used to generate hydrogen in a wide variety of locations, for example, on a moving vehicle.

Generation system 101 uses electric energy that is generated by an energy source 111 that is outside the vessel 102. For example, the energy source may be photovoltaic cells, a wind turbine, or a regenerative braking generator placed a distance from the vessel. It will be appreciated that these energy sources may be used individually, or may be used in any combination, and may be used to recharge a battery.

In use, the hydrogen generation process first generates an electric current. The electricity may be produced, for example, by a solar panel associated with the vessel where the hydrogen will be produced. In some cases, the solar panel may even be placed in the electrolyte solution, or the solar panel may be separated form the electrolyte by a glass partition. In some constructions, the electrolyte solution may advantageously concentrate light rays onto the solar panel. Alternatively, the electricity may be generated external to the vessel by a solar panel, wind turbine, or regenerative generation.

Anode and cathode electrodes are separated by a membrane 117, which is preferably a proton-passing membrane. By adjusting the characteristics or dimensions of the membrane, the electrolysis process may be moderated or otherwise controlled. The generated electricity is applied to the anode and cathode electrodes in the electrolyte solution, which causes hydrogen to be produced at the cathode electrode and oxygen to be produced at the anode. The hydrogen gas bubbles through the electrolyte solution and is trapped by the membrane in a hydrogen collection volume, and the oxygen may bubble through the electrolyte and be trapped by the membrane in an oxygen collection volume. Since the membrane may be selected to restrict passage of both hydrogen and oxygen, the membrane keeps the generated hydrogen and oxygen from mixing. Preferably, the same membrane is used for controlling the electrolysis process and for trapping the hydrogen gas, although separate membranes may be used.

The hydrogen may then be exhausted through a pump for storage in a low-pressure tank, or may be directly used or consumed. In a similar manner, the oxygen may be exhausted as waste, or may be collected or used.

The generation system applies electrical energy, preferably from a renewable source, into a vessel or case for photoelectrochemical hydrogen production. There is no separate electrolyzer as in known systems. This solar direct electrochemical process may use solar exposure on immersed photovoltaic cells to power anodes and cathodes in the electrolyte to produce the fuel gas, hydrogen. By eliminating the traditional electrolyzer, the overall cost to produce hydrogen is reduced as electrolyzers are expensive and can reduce efficiency by consuming as much as 40% of the available electricity. In the present process, the original high capital cost of the electrolyzer is eliminated. The primary concentrating process is a combination of aqueous electrolyte solution and lenses that provide solar concentration. Also the vessel or case may receive electricity from wind turbine or regenerative generator to augment the solar power.

The disclosed generation system uses an electrolysis process to generate hydrogen from an electrolyte solution. In an electrolyte-water solution the hydrogen ions have a positive (+) charge and these become attracted to the negative (−) cathode to produce hydrogen. The oxygen ions have a negative (−) charge and they become attracted to the positive (+) anode to produce oxygen. The hydrogen ions are attracted to the negative electrode where they receive electrons, become stressed by over loading and combine to form the hydrogen molecule. Likewise, the negative oxygen ions migrate toward the positive terminal in the electrolyte to give up an electron and combine to form the oxygen molecules. Electro catalysts such as platinum may be used as an electrode or a coating on an electrode to reduce the amount of energy needed to break apart and oxidize hydrogen gas.

In the hydrogen generation system, as the splitting of the water takes place, hydrogen and oxygen are produced on separate sides of the membrane and collected in separate containers or chambers. Thus, the gases are respectively channeled from the high concentration pressure in the electrolyte toward two separate low pressure reservoirs for hydrogen and oxygen. The hydrogen is them transferred to a low-pressure storage tank, or consumed by a fuel cell or combustion engine.

Accordingly, the direct photoelectrochemical process combined with wind and regenerative generator energy can be used to produce hydrogen while requiring no fossil fuel such as gas or diesel, and substantially reduces the dependency on refueling stations. In addition, the present process produces hydrogen energy on-board to provide a substantial, if not all, the energy needs for a vehicle. The requirement for traditional distribution equipment, related pollution, and the associated costs are eliminated. The disclosed generation system is also scalable from small vehicles to large trucks, and may be used to power portable equipment, such as refrigeration units. It is easily mass produced and arranged in multiple units, thus reducing the overall cost impact to a vehicle.

An advantage of the solar photoelectrochemical water splitting process is that it only requires about 1.3 Volts Direct Current to split water into hydrogen and oxygen. This electrical principal operates by the flow of protons through a polyelectrolyte membrane (PEM) from a positive anode to a negative cathode where the hydrogen is generated. The electron flow is from the anode to the cathode separately. Electro catalysts may be used to enhance the hydrogen generation. A typical arrangement may have several generating tubes, each requiring only 1.3 to 2.2 Volts DC to split water. A voltage splitter is employed to divide available voltages from the several electrical generating sources and electrical storage systems and split the voltage to the requirement of each single generating tube in the hydrogen generator. Low voltages are easily generated from air movement at standard vehicle speeds ranging from 10 and 70 MPH or higher, down to stopping by braking power. The vehicle can also be driven or parked in solar exposure and electricity and consequently hydrogen will be generated, even when the vehicle is not moving. A further advantage is that PEM fuel cells require relatively low hydrogen gas pressures, such as 3 psi to 8 psi, so hydrogen may be readily received from the main storage tank. With multiple cells in the hydrogen generation case, significant quantities of hydrogen can be generated by splitting the higher voltage such as 12 Volts and 24 Volts or other voltages, into this lower voltage and then wired into a number of independent case chambers. This implementation, with its low voltage requirement for water splitting is surprising efficient as compared to designs that include high pressures, high heat, and generators requiring much higher voltage requirements such as 120, 240, 460 volts, or higher.

The hydrogen generating system defined here may also generate electricity from air and wind passing over and through any moving vehicle. Employing funneled concentrating air entry and vortex style wind tunnels with an electrical turbine, the air movement speeds of a vehicle moving at starting miles per hour on up to 60 and 70 and higher rates of speed, are expected to turn the small turbines anticipated in this project without hindering the overall speed of the vehicle using controlled air intake gating. Opening the control gates full for full wind exposure to the turbine blades will also have braking effect on the vehicle. A small turbine designed to generate 1.3 volts DC with unique aerodynamic blades that create a vacuum on the back of the pulling side of the blade, opposite the pushing side of the blade, is expected to achieve maximum energy on the turbine blades. Any pressure on the blades is expected to reduce overall vehicle speed. Such turbines and blades may have various diameters. Having diameters possibly as little as two or three inches and with expected design with low weight composite materials, they are not expected to inhibit vehicle speed significantly when the wind tunnel is used for controlled generation of low voltage electricity. The design of the air intake opening and turbine blades also includes a more open application for vehicle breaking.

The electrochemical hydrogen generator may have one or more tubes containing positive (+) and negative (−) electrodes and a membrane for separating the electrodes, which also serves to keep the hydrogen and oxygen completely separated as they are generated, so that no further separation of these two gases is required. Tubing with a humidifier and check valve and a pump may be included as needed. Electrical connections from the electrical storage module are attached to the tubes. This provides electricity to the hydrogen generating case to support the electrolysis process, and thereby yields a continuous hydrogen flow when electricity is sent from the electrical storage. A Hydrogen humidifier may follow the hydrogen generation stage before storage.

On-board generated hydrogen is stored in a tank using a hydrogen pump, and the tank also has an exit port to a fuel cell or combustion engine. Another exit port may be provided for off-loading hydrogen to a stationary storage. A high pressure reserve storage tank may also be provided with an input port and outlet tubing and check valve. The separate reserve storage container has a filling cap for receiving off board fuel. The reserve tank provides readily available hydrogen fuel for starting the vehicle and providing fuel when the main tank is low or depleted. The low pressure storage system provides the opportunity for continuous storage from the hydrogen generation capability. Accompanying controls provide for filling the reserve storage container and flowing hydrogen into the fuel cell for power when vehicle, air movement or solar energy has not provided for sufficient on-board hydrogen production.

The hydrogen fuel cell generates electricity from hydrogen to power the vehicle wheels. Only water—no pollutants—exits the fuel cell. Electricity from the fuel cell is operator controlled and directed to the electric motor at the wheels which propels the vehicle. With the available electricity from the several on-board electrical sources and the on-board electrical storage, the hydrogen generator will generate hydrogen on an as needed basis.

In another use, the electricity generated by the fuel cell may be used to operate a portable refrigeration unit. The refrigeration feature is for providing hydrogen gas for such units as long-haul truck refrigerated tailors, which currently use diesel or kerosene as fuel and to power the refrigeration units on their refrigerated trailers or trucks. This disclosure defines a system of regenerative braking, air movement, and solar photovoltaic electricity generation for a photoelectrochemical hydrogen generator. The hydrogen thus generated is used in either fuel cells to provide electricity on demand or to be used as a flame similar to propane and natural gas (both fossil fuel sources) for powering the refrigeration unit.

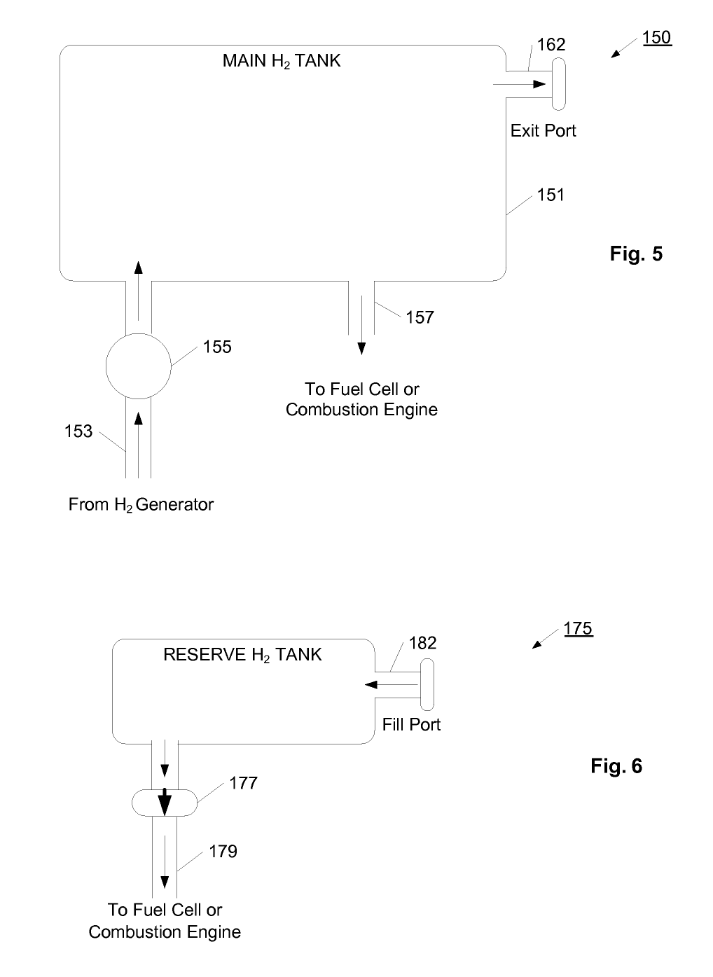

Referring now to FIG. 5, an example of a main hydrogen tank 150 is illustrated. The main hydrogen tank 150 may operate at a relatively low pressure as compared to the high-pressure reserve tank. In some cases, this means operation at 200 psi or less. In other cases, other pressures may be selected according to the type of propulsion system used, or other vehicle requirements. The construction and mounting of a hydrogen tank is well understood, so will not be described in detail. The main hydrogen tank 151 receives hydrogen gas from a hydrogen generator through a pipe 153. A pump and check valve system 155 may be used for drawing hydrogen gas into the main tank 151. For example, hydrogen received from the hydrogen generator may be at only a few psi, so the pump 155 is used to raise the pressure to the higher pressure in the main tank 151. The main tank 151 also has an exit port 157 that is received into a fuel cell, combustion engine, or other propulsion system. It will be appreciated that various controls, valves, and pressure reducing devices may be used. For example, a fuel cell typically receives hydrogen gas in the range of three to 12 psi. Accordingly, if port 157 is connected to a fuel cell, a pressure reducing device may be needed. In some cases, the on-board hydrogen generation system may generate more hydrogen than used by the vehicle. This may occur, for example, if a vehicle is parked in a sunny or windy area for a length of time. While the vehicle is parked, the generation system continues to generate and store hydrogen, even though the vehicle is not consuming any. Accordingly, an exit port 162 may be used for a mating device to extract excess hydrogen gas from the main tank. This may be useful, for example, for a homeowner to extract excess hydrogen from a vehicle for local storage or other use.

Referring to FIG. 6, a reserve hydrogen tank 175 is illustrated. Reserve tank 175 has a fill port 182 for receiving high-pressure hydrogen gas from a refueling service station. The construction of a high pressure hydrogen tank and fill port is well known, so will not be described in detail. The hydrogen tank 175 also has a check valve and pressure reducing system 177 for flowing hydrogen into a fuel cell or combustion engine for consumption. Typically, the hydrogen will only flow from the reserve tank 175 to the propulsion system when the main tank has been depleted or is low. Accordingly, the reserve tank system has a valve on out-line 179 for controlling when reserve hydrogen is used. It will also be understood that the reserve tank 175 may be used to replenish the main tank 150, rather than flowing hydrogen directly to the propulsion system.

The hydrogen generation case may be, for example, a glass or composite tube. It contains a system of electrodes with cathode and anode separated by a membrane whereby, in the presence of electrical current suited to splitting water into its components. A photoelectrochemical reaction takes place, or an electrochemical reaction takes place if there is not direct solar exposure into the tube, but electricity may be directed to the tube from other sources, yielding hydrogen and oxygen. In this system the hydrogen and oxygen are generated as separate gases. They are not mixed and therefore do not need to be separated later. The hydrogen flows out of the case in a tube and through a humidifier that removes excess water vapor that may be in the hydrogen. Following the humidifier is a pump to sends the hydrogen into a low-pressure main storage. The main hydrogen storage container receives hydrogen through a system of tubing including a one way valve and a pressurizing pump. A separate reserve storage tank, fill-able by outside stationary or portable source, is also connected that stores hydrogen for starting and beginning vehicle travel. A fuel cell receives hydrogen, where it is consumed to generate electricity. Electricity from the fuel cell passes to the vehicle's wheel motor or motors, which in turn powers the vehicle wheels.

The hydrogen generator employs a system of electrodes, and electrolyte with membrane separation, which in the presence of low voltage current, splits water into its components. This method of water disassociation creates the components, hydrogen and oxygen, in completely separate chambers for piping off to storage or to exhaust in the case of oxygen. When hydrogen enters the fuel cell it gathers oxygen as needed for the reaction from the surrounding air. While solar energy exposure is available to the photovoltaic cells on the vehicle, either when the vehicle is moving and or when it is stationary, hydrogen production is enhanced for fuel cell electrical generation to the wheels or to augment hydrogen storage. The dual storage system provides hydrogen to the fuel cell as required for startup, idling, slow traffic conditions, and full highway speed operation. Hydrogen generated and stored in the vehicle may also be piped and used outside the vehicle, to power other fuel cells or hydrogen fueled power devices when the vehicle is parked at a business or residence. The vehicle therefore serves as a mobile energy generating source.

Where large vehicles such as long-haul trucks and busses employ this technology, with their continuous high speed travel, and exposure to solar energy from large roof space and kinetic energy from braking and resistance of the turbine blades it is anticipated that they will produce excess hydrogen for bleeding off for other applications including air conditioning and refrigeration, both stationary and mobile. Such benefits are anticipated because this system requires very low voltage for water disassociation. This system and method for onboard motor vehicle hydrogen gas generation using renewable energy by portable water disassociation also is suitable for application in balloons and dirigibles, for both low and high altitude airships, as well as for airplanes and certain over the water vessels.

Available hydrogen from the proposed system and method is not limited as an energy carrier for fuel cell operation but may also be employed to power internal combustion engines and generators that are setup for hydrogen. Surprisingly no carbon based fuel, fossil fuel, or grid electricity need to be used for the operation of this system. In many applications, only renewable energy resources of wind, moving air, regenerative braking, and solar energy are employed for this method of operation. This does not limit the employment of utility grid electricity or carbon based fuel as alternative sources of hydrogen to augment hydrogen storage and use of off-board generated hydrogen in the present system and method. Operation of the system and method in the present work may include the generation of hydrogen in the vehicle, either moving or parked. Such hydrogen may then be piped off the vehicle and used in a stationary hydrogen generator at a residence, business, or government location. In this instance, the vehicle may have been either mobile or parked generating hydrogen and the hydrogen thus generated may be connected and piped into a stationary application for hydrogen use in fuel cells for electricity or for combustion applications. Stored hydrogen in stationary application could be used to replenish the storage tanks on the vehicle to fill future needs. Further, operation of this practical portable method of producing hydrogen may be set up to be used as flame or firing for gas in internal combustion engines, and ovens and furnaces, or on trains or trolley or in steam engines powering vehicles or stationary locations and may also have many other practical uses not listed here.

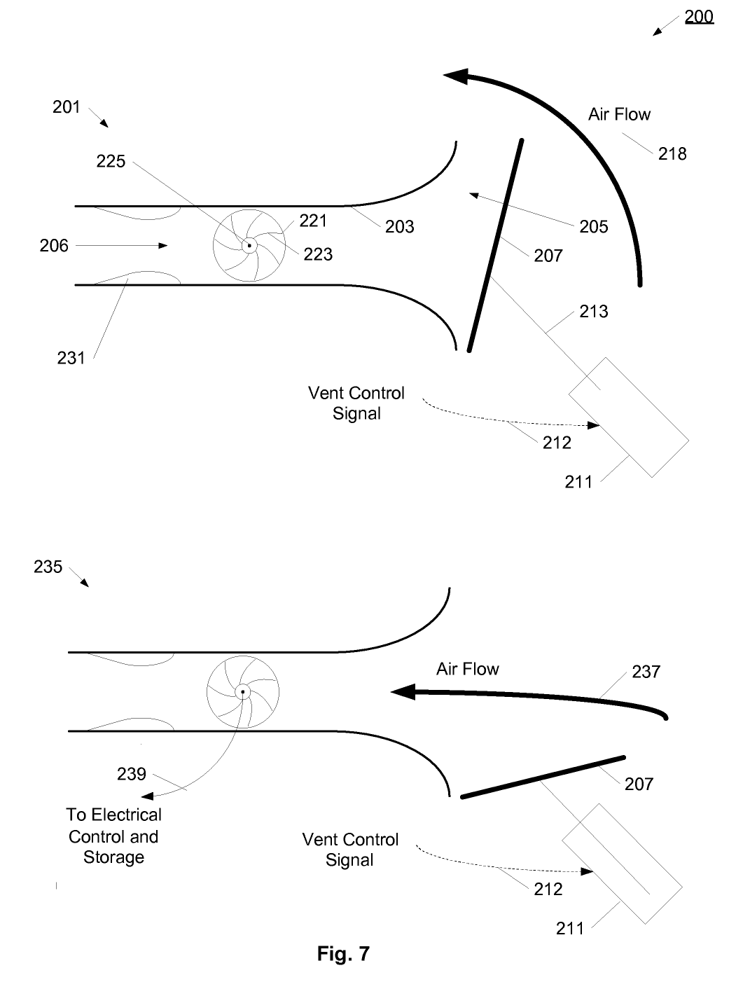

Referring now to FIG. 7, a wind turbine system 200 is illustrated. Wind turbine system 200 is intended to be mounted onto a motor vehicle for providing electrical energy for powering a hydrogen generator. The wind turbine system 200 is illustrated in a first position 201 for when the mobile vehicle is accelerating, or no excess kinetic energy is determined to be available. Accordingly, the turbine system 200 has a connection to a controller or a vehicle processor for determining when excess kinetic energy is likely to be available, for example, when braking. It will be appreciated that excess energy may also be available when the vehicle is coasting or moving down an decline, for example. When no excess kinetic energy is available, vent control signal 212 instructs an actuator 211 to close vent 207. The inlet 205 to the wind turbine is shielded from airflow 218, so the airflow moves aerodynamically around the vehicle. In this arrangement, the wind turbine fan 221 is not turning, as little or no wind is hitting the individual fan blades 223. Since the fan 221 is not turning, the generator 225 is not producing electricity.

As shown in arrangement 235, when the vehicle detection system detects that excess kinetic energy is available, a vent control signal 212 is sent to the actuator 211. The vent signal causes the vent 207 to open, allowing an airflow 237 to be received into the wind turbine. The inlet 205 to the wind turbine is shaped to allow a concentration of airflow for increased turbine efficiency. It will be appreciated that several shapes may be used for providing this concentration. The airflow is received at the blades 223 of the fan 221, thereby causing the fan to rotate. The generator 225, which may be positioned concentric with the fan or may be positioned outside the wind turbine, is driven to provide electrical current 239. The electrical current is passed to the electrical controller storage system where it may be used to drive the hydrogen generation system. The turbine also has an outlet 206 which has protrusions 231. These protrusions are shaped and positioned to cause increased turbulence in the outlet 206. This increased turbulence facilitates an increased drag, facilitating braking or slowing of the vehicle.

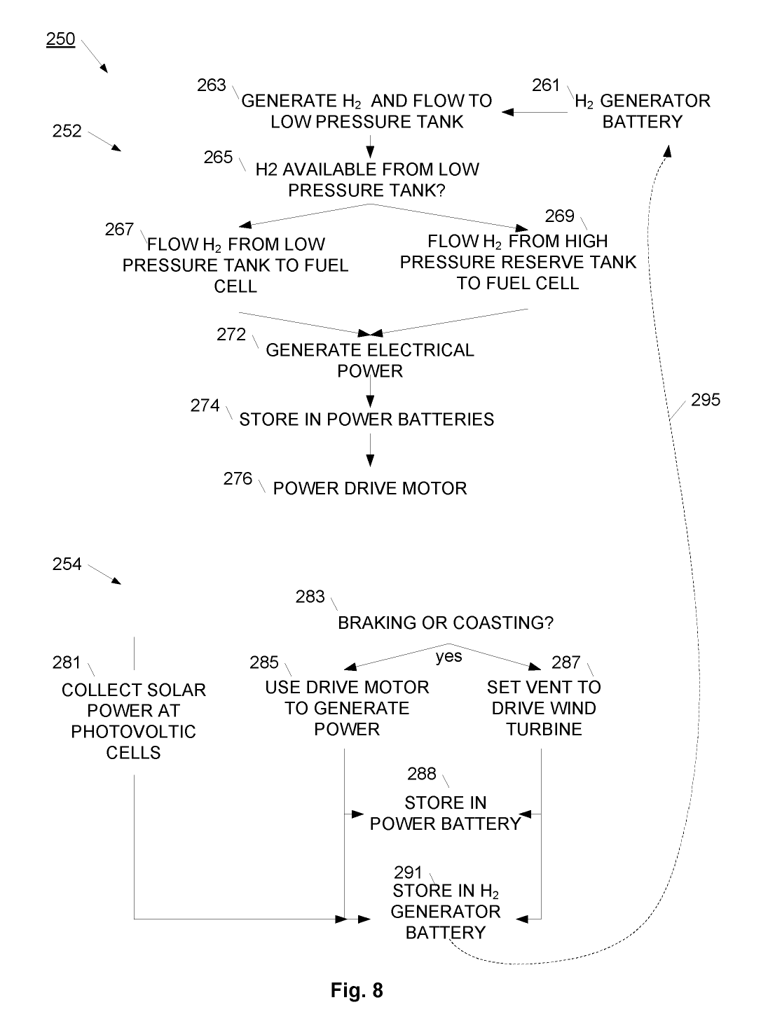

Referring now to FIG. 8, a method of using a hydrogen generation system to power a motor vehicle is illustrated. Method 250 has a storage battery 261 that stores electrical power. The electrical power from the battery is used to drive an electrolysis process in a hydrogen generator as shown at block 263. The generated hydrogen is flowed into a low-pressure hydrogen tank. A vehicle control processor may determine if the low-pressure tank has sufficient hydrogen to operate the vehicle as shown in block 265. If so, hydrogen is flowed from the low-pressure tank to a fuel cell as shown at block 267. If not, one or more valves are positioned so that hydrogen flows from the high-pressure reserve tank to the fuel cell. The fuel cell uses the hydrogen to generate electrical power as shown in block 272, with the generated power stored in power batteries as shown in block 274. The batteries are then used to power drive motors as shown in block 276, typically responsive to driver commands.

A hydrogen regeneration process 254 may be operated continuously or continually. For example, the solar capture and conversion may be performed even when the vehicle is not moving, although the regenerative generation processes require the vehicle to be in motion. In another example, a wind turbine may operate using ambient wind, even when the vehicle is parked. In this way, a parked vehicle may be able to regenerate hydrogen by using ambient wind as well as solar power. Regenerative process 254 may collect solar power at photovoltaic cells as shown at block 281. These photovoltaic cells are typically mounted on the roof of a vehicle or in another position for receiving direct sunlight. This energy may then be used to store electrical power in the generator battery as shown in block 291. A vehicle sensor may be used to determine if the vehicle is braking or coasting as shown at block 283. If the vehicle is braking or coasting, the processor system may configure the electric drive motors to generate electricity as shown in block 285. This power may be used to store in the power battery as shown at block 288, or in some cases may be also be used to replenish the hydrogen storage battery as shown in block 291. In a similar manner, when the vehicle is braking or coasting, the vehicle control systems may set a vent to allow air to flowed into a wind turbine. The wind turbine drives a generator which again may store power in the power battery as shown at block 288, or may store power in the hydrogen battery. In another example, the vehicle processor may detect that the vehicle is parked, and set the vent to the wind turbine to an open position, thereby allowing ambient wind to drive the wind generator, even when the vehicle is not moving.

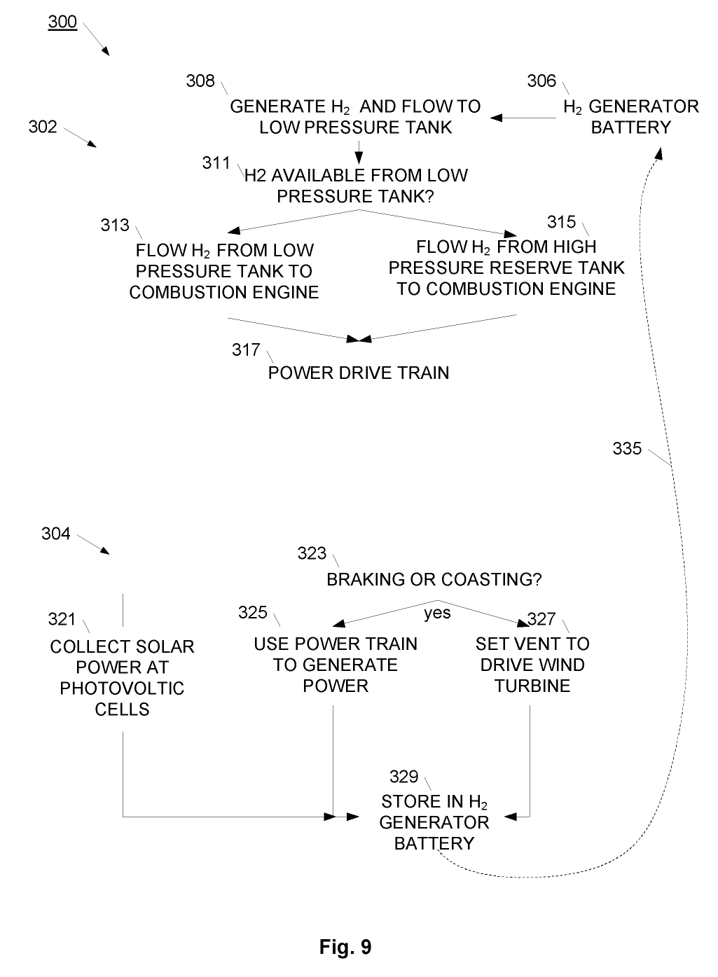

Referring now to FIG. 9, a method for using a hydrogen generation system for a vehicle is illustrated. The method 300 has a generator battery 306 that provides electrical power to support an electrolysis process to generate hydrogen as shown in block 308. The hydrogen is flowed into a low-pressure tank. A vehicle processor determines if sufficient hydrogen is available in the low-pressure tank as shown at block 311, and if so, flows hydrogen from the low-pressure tank to a combustion engine as shown in block 313. If the main low-pressure tank is low or depleted, hydrogen may be flowed from a high-pressure reserve tank to the combustion engine as shown in block 315. The combustion engine then drives the power train as shown in block 317.

A regeneration process 304 may be used either while the vehicle is moving or not moving. When the vehicle is not moving, electrical energy may be generated using solar photovoltaic cells or by using a wind turbine generator. When the vehicle is moving, the solar generator may continue to operate, and the wind turbine may operate when a sensor detects that the vehicle is braking or coasting as shown in block 323. Accordingly, when the vehicle is braking or coasting, a vent is set to allow airflow through the wind turbine as shown in block 327. Electricity generated may then be stored back in the generator battery as shown in block 329. Also, when the vehicle is braking or coasting, a power train generator may be used to generate power as shown at block 325. Again, this power may be used to replenish the generator battery. In this way, the regeneration system 304 is used to replenish the generator battery 306.

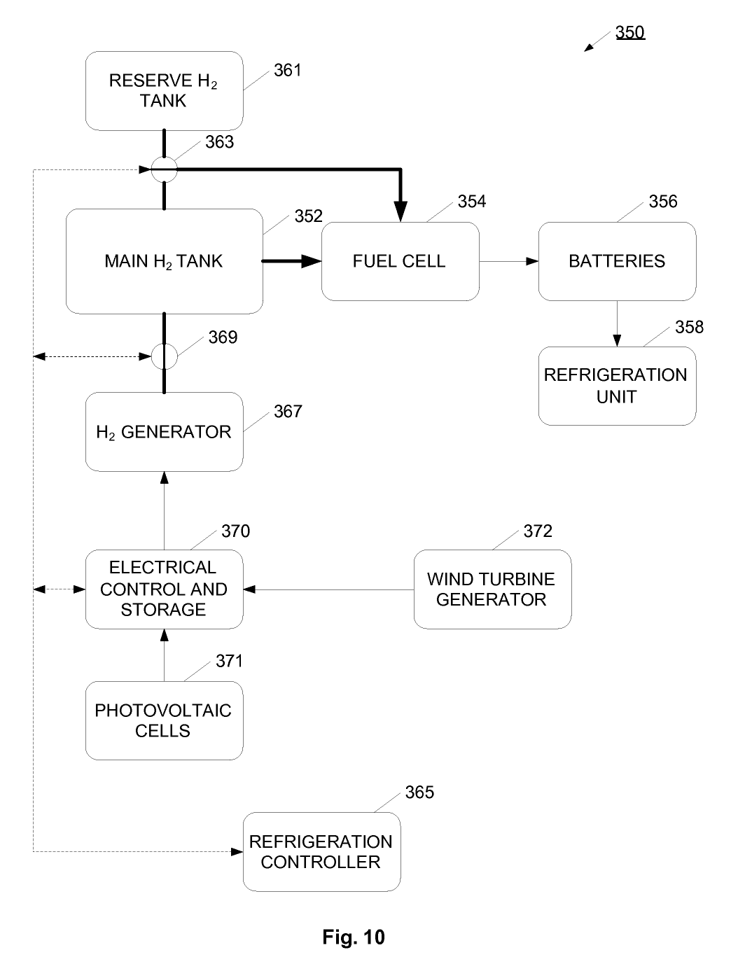

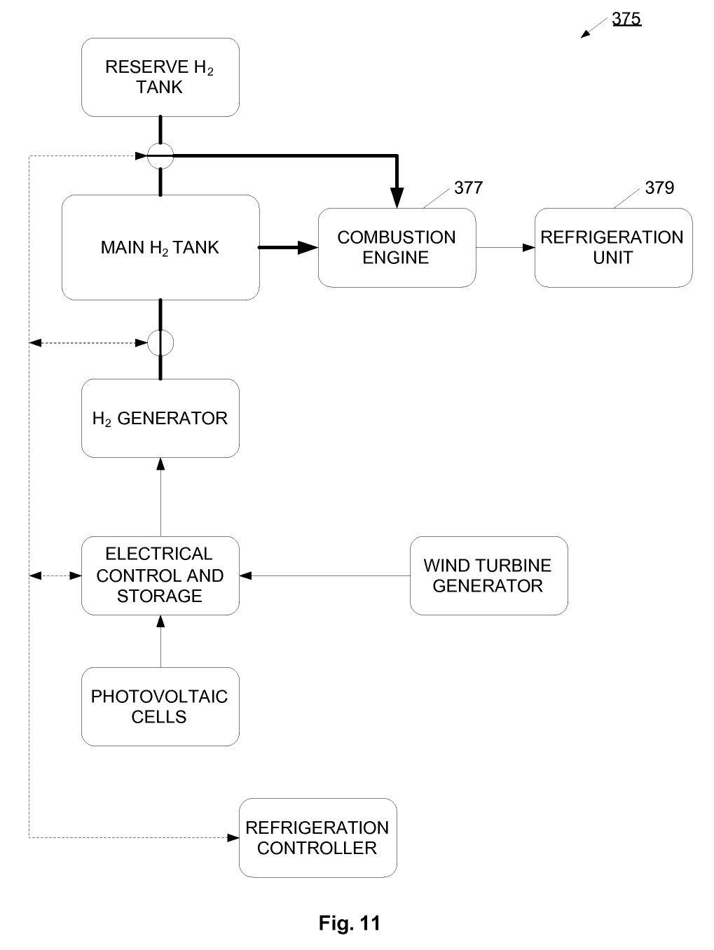

Referring now to FIG. 10, a hydrogen regeneration system 350 is illustrated. Hydrogen regeneration system 350 has a main low-pressure tank 352 for providing hydrogen gas for a fuel cell 354. The fuel cell 354 generates, using an electrolysis process, electricity that is stored in batteries 356. The electricity is used to power the refrigeration unit 358. In one example, refrigeration unit 358 is a refrigeration unit for a mobile vehicle such as a truck. Such refrigeration units are typically used to provide cooling for transport trucks when the trucks are parked. The fuel cell 324 may also receive hydrogen from a high-pressure reserve take 361 if the main tank 352 is low or depleted. A refrigeration controller 365 determines when the fuel cell should operate, and from which tank hydrogen should be drawn. A valve 363 may be used for directing hydrogen to replenish the main tank 352 or to directly flow hydrogen into fuel cell 354. An on-board hydrogen generation system 367 uses an electrolysis process for replenishing the main hydrogen tank 352. A pump and check valve 369 may be used for drawing hydrogen gas at a relatively low pressure from the generator 367 to be stored in the main tank 352.

Generator 367 uses an electrolysis process to generate hydrogen gas, and is powered by electrical control and storage system 370. The control and storage system 370 may have electrical control circuits as well as storage batteries. A photovoltaic cell system 371 may be used to replenish the control and storage system 370, both when the vehicle is moving and when stationary. A wind turbine generator 372 may also be used to replenish the control and storage system 370. The wind turbine generator 372 may operate when the vehicle is stationary using ambient wind, or may be associated with a vent control system for flowing air into the wind turbine generator 372 when the vehicle is coasting or braking. Accordingly, the photovoltaic cells 371 and wind turbine generator 372 act to replenish electricity in the control of storage system 370, which in turn permits further operation of the hydrogen generator 367. If the regeneration systems do not provide sufficient hydrogen, then the reserve tank 361 may be used to drive the refrigeration process.

Referring now to FIG. 11, a hydrogen generation process 375 is illustrated. Process 375 is similar to process 350, so will not be described in detail. Generation process 375 has a combustion engine 377 instead of the fuel cell as previously described. The combustion engine is used to drive a refrigeration unit 379 for providing cooling for the storage area of a refrigerated truck. As described with reference to FIG. 10, the main hydrogen tank is regenerated using an on-board hydrogen generator that uses an electrolysis process. The electricity for the electrolysis process may be regenerated through the use of photovoltaic cells and a wind turbine generator.

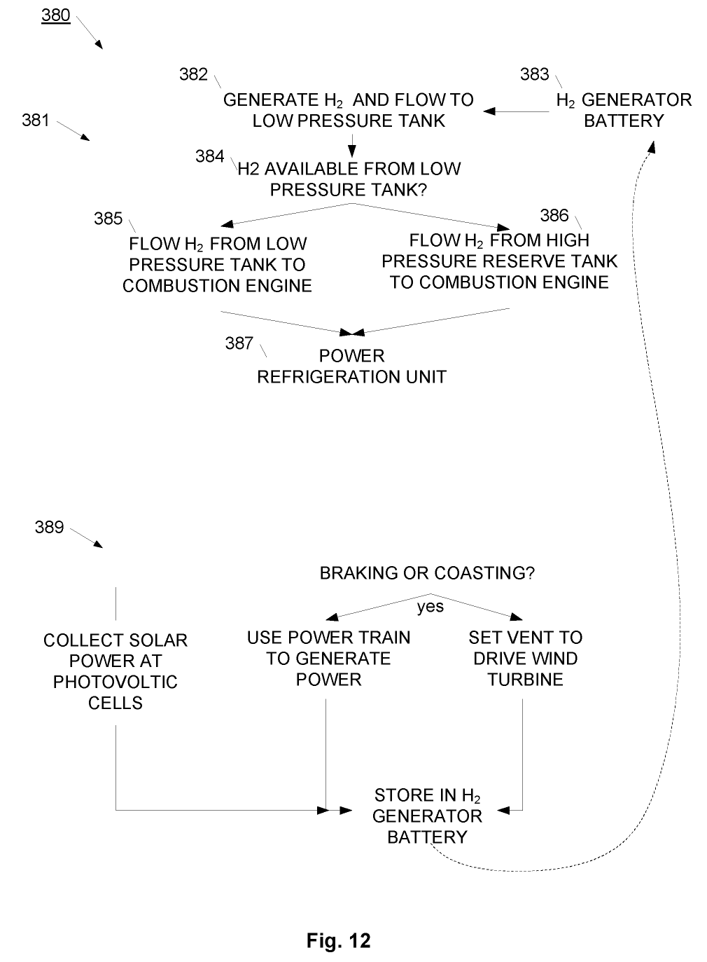

Referring now to FIG. 12, a process 380 for powering a refrigeration unit is illustrated. The method 380 has a generator battery 383 that provides electrical power to support an electrolysis process to generate hydrogen as shown in block 382. The hydrogen is flowed into a low-pressure tank. A vehicle processor determines if sufficient hydrogen is available in the low-pressure tank as shown at block 384, and if so, flows hydrogen from the low-pressure tank to a combustion engine as shown in block 385. If the main low-pressure tank is low or depleted, hydrogen may be flowed from a high-pressure reserve tank to the combustion engine as shown in block 386. The combustion engine then drives a refrigeration unit as shown in block 387. The refrigeration unit may be, for example, a refrigeration unit for cooling the transport volume of a refrigerated truck. As described previously, the regeneration process 389 may use solar, airflow, ambient wind, and regenerative braking to recharge the generator battery 383, and therefore enable the production of more hydrogen gas.

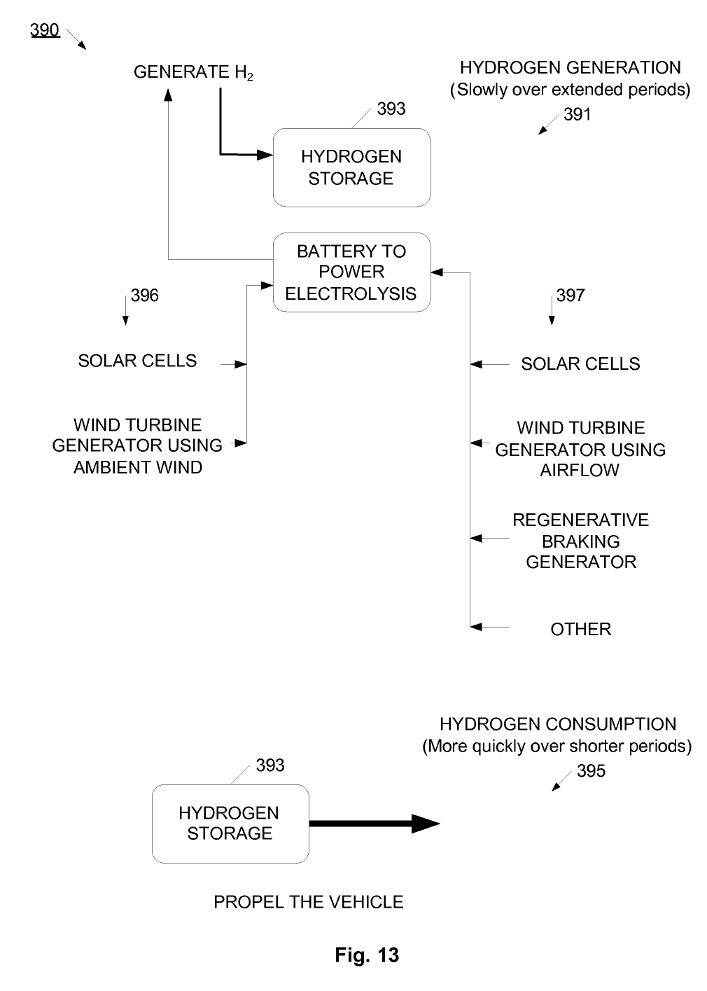

Referring now to FIG. 13, a method for managing hydrogen is illustrated. Method 390 is advantageously used as a hydrogen management system on a mobile vehicle such as a car or truck. The car or truck is constructed with an on-board hydrogen generation system, which may be a hydrogen generator as discussed with reference to FIG. 4. The vehicle also has multiple on-board sources of electricity, which may be used to supply energy for a hydrogen electrolysis process. The electrical sources may drive the electrolysis process directly, but more likely are used to recharge a generation battery to drives the hydrogen generation process. To more effectively function to provide hydrogen as a fuel for propelling the vehicle, hydrogen may be continually generated over long periods of time. For example, the hydrogen generator may be constructed for supplying a relatively low volume of hydrogen gas over a long period of time, with the gas stored in local storage tanks. In this way, hydrogen may continue to be generated even when the vehicle is not actively being used. Method 390 shows that when the vehicle is stationary, multiple electricity sources 396 may be available. For example, solar cells may be used to collect solar energy to recharge the generation battery. In another example, a wind turbine may be arranged to receive ambient wind to drive a generator, thereby generating electricity which may be used to also recharge the generation battery. At other times, the vehicle may be moving and have other electricity sources 397 which may be available. Of course, solar cells may continue to capture solar energy, and the wind turbine may be arranged to capture excess kinetic energy by adjusting a vent responsive to detecting a braking or coasting condition. Further, when braking or coasting is detected, a regenerative braking system may also be used to capture kinetic energy from the vehicle's drive system.

It will also be appreciated that other energy capture systems may be used. For example, the vehicle may employ one or more generators or piezoelectric devices for converting shock or vertical motion into electricity. These vertical movements are wasted energy, which may be used to drive small (but significant in the aggregate) electrical currents. Again, all the renewable and regenerative processes may be used to keep the generation battery charged. At times when the generation battery has electrical power available, it drives the hydrogen generation process. Accordingly, a vehicle may nearly continuously generate and store hydrogen. Even though the hydrogen generator may be sized for generating and flowing a relatively small volume of hydrogen, over an extended period, this can provide a significant amount of hydrogen gas. For example, a car parked in a sunny parking lot on a windy day may generate sufficient electricity to both power the hydrogen generator and to keep the generation battery fully charged. Even as the car remains parked overnight, the electrical battery may be used to drive the hydrogen generation process throughout the night. In this way, hydrogen may be produced at nearly all times for the vehicle.

When the vehicle is driven, a relatively high volume of hydrogen will be used for shorter periods of time as shown at 395. In this way, a relatively high volume of hydrogen will be flowed from the storage tank 393 and consumed by a fuel cell or combustion engine. By appropriately sizing the hydrogen storage tanks, the generation battery, and the electrical regeneration systems, the hydrogen regeneration system may scaled to accommodate a variety of desired ranges, vehicle duty cycles, and vehicle types. Preferably, the system is sized so that the hydrogen and electrical regenerative processes 391 provide most of the hydrogen needed for the anticipated use. However, for times when use exceeds the availability of regenerated hydrogen, a reserve hydrogen tank may be provided.

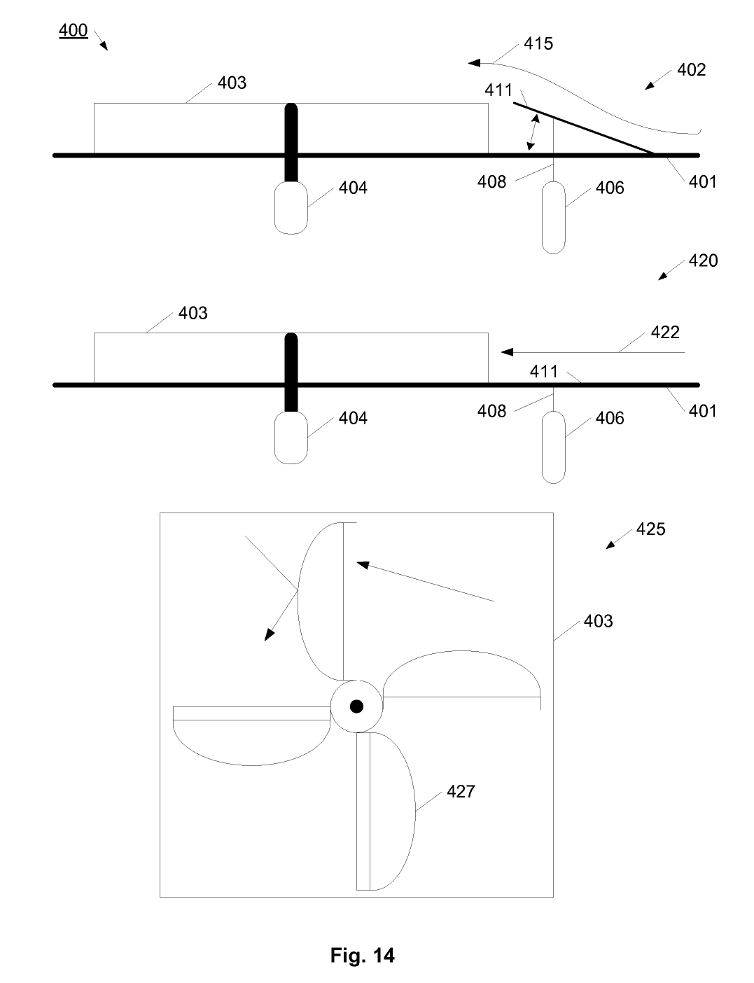

Referring now to FIG. 14, a wind turbine system 400 is illustrated. Wind turbine 400 may be mounted, for example, on the roof 401 of a truck or other mobile vehicle. When the truck is accelerating or being powered forward, a signal is sent to an actuator 406 that drives an actuator rod 408 to position a vent 411 so that air flow 415 is moved around a fan body 403. In this non-operating position 402, the fan blades are not driven, and therefore the generator 404 generates no or almost no electricity. However, when the vehicle controller or processor detects that the vehicle is braking or coasting, the actuator 406 causes the vent 411 to be positioned so that air flow 422 is received directly into the fan body 403. Since the fan blades are now spinning, generator 404 now generates electrical power. Also, the vent 411 may be lowered when the vehicle is positioned in a long-term stationary position, for example, when parked. In this arrangement, the wind turbine would continue to generate electricity according to the availability of ambient wind.

The wind tunnel has a number of unique features, for example, the air intake may be opened or closed by control system when braking is sensed, and may also increase resistance to assist in braking the vehicle. The input opening has a wide area that narrows providing vortex concentration of the air and increases wind pressure impingement on the turbine fins or blades. The blade fins are uniquely designed to face air before it reaches the turbine and at blades at the rear of the turbine. There is a lift aerodynamic design to the individual blades. The rear blades use the trailing air movement to gain more energy on the turbine. The bearings of the turbines are of unique low friction design. The air exit from the turbine may include protrusions to cause vortex turbulence that pulls the air flow to increase pressure on the blade fins and for creating more drag for braking. In some wind/air movement cases, there is an open option to have multiple smaller turbines to yield the required low voltage for water splitting to the multiple segments of the hydrogen generating case.

Advantageously, the fan is constructed so that irrespective of wind direction, the fan rotates in one direction. As shown in illustration 425, each fan blade 427 is cup shaped, and positioned such that an approaching wind may be received into the cup, thereby driving the fan in a single direction. Wind received at an opposite blades is deflected from around the backside of the fan blade. In this way, even when the vehicle is parked, an ambient wind may be received from any direction, and the fan is highly likely to rotate in only one direction, thereby keeping proper polarity for a generated current.

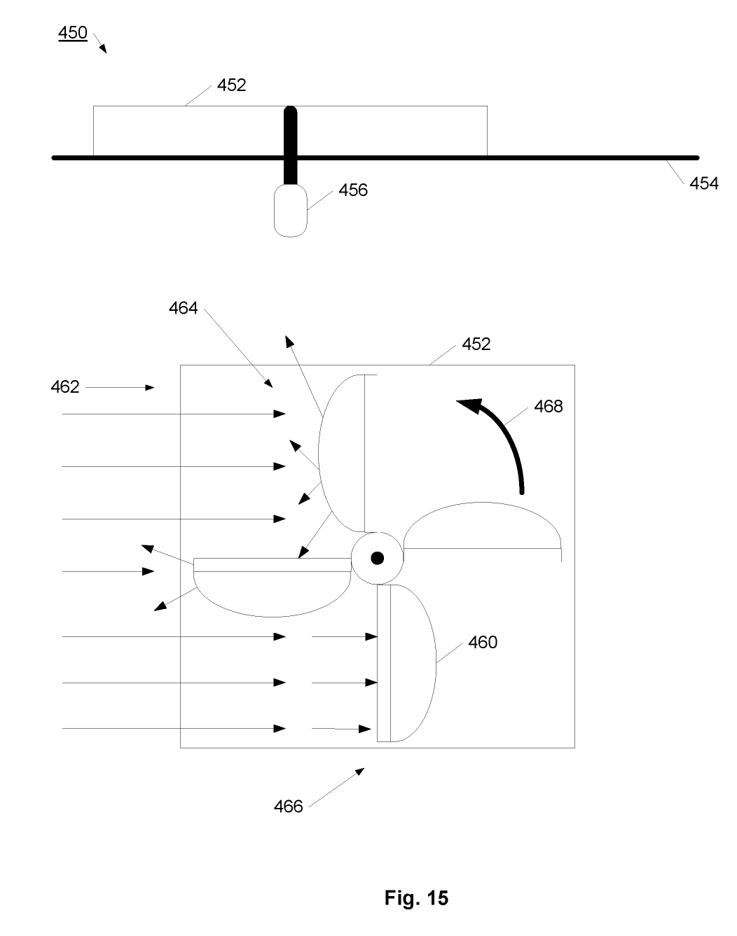

Referring now to FIG. 15, further detail is provided for a wind turbine fan. The fan 450 may be advantageously mounted on a surface such as a roof 454 of a vehicle, or on another surface likely to receive wind or airflow. The fan 450 has a fan body 452 which has a center spindle connected to a generator 456. The generator may be integrally formed with the fan body 452, or may be positioned at a different location. When a wind is received in a wind direction 462, the wind is received at fan blade 460 and will be received into the cup shape 436 of the front side of the fan blade. Due to the shape of the blade and its cup-shaped wind receiving portion, the wind received most directly into the cup will impart the most force on the fan. This wind will drive the fan in a rotational direction 468. Wind received at the back side of the fan blade 464 will be deflected as illustrated. The force generated by the wind received into the cup-shape will be greater than the force applied to the fan blades by the deflections 464, thereby assuring that the fan blade moves in direction 468. In some cases, the direction of the wind may be controlled, for example when the vehicle is moving. However, in other cases, for example when the vehicle is parked, the wind direction may be more random, so the blade construction of fan 450 is likely to assure that the fan nearly always rotates in a single direction only. In this way, polarity of a DC output current remains the same, irrespective of wind direction. Although fan 450 is illustrated and described in use on a mobile vehicle, it will be appreciated that the fan would also be useful for static locations such as homes, buildings, and refueling stations.

A system and method for generating hydrogen gas has been described. The portable system uses renewable electricity sources to generate hydrogen gas onboard a moving vehicle. This system and method may employ multiple sources of renewable and kinetic energy from the sun, regenerative wheel braking and regenerative braking from air movement or wind, multiple electrical storage systems as well as the electrochemical water splitting system onboard a vehicle to generate hydrogen. The hydrogen is used to for fuel cell electrical generation to drive the vehicle wheels, as fuel for a combustion engine, or to operate a refrigeration or air conditioning unit. The system is also capable of accepting and storing hydrogen for onboard use from a stationary filling station not located on the vehicle. This portable vehicle hydrogen generating system may also off-load hydrogen generated on the vehicle for use in stationary applications.

The disclosed system and method greatly reduce the required infrastructure for filling stations along every travel distance. It employs a portable onboard vehicle generation system for hydrogen, using only renewable sources, with much reduced requirement for stationary fuel service stations, except as the backup to fill the reserve tank. No fossil carbon based fuels are required; that is no gasoline, natural gas, hybrid, diesel or other alternative gas or liquid fuel, nor is utility electricity required. This feature reduces end user requirements for local filling stations and lowers costs dramatically, by eliminating liquid or compressed fuel refining, storage, and transport costs. The methods include here capture kinetic energy from the vehicle regenerative wheel braking system, and a regenerative braking system employing resistance of air flow of the moving vehicle against fan blades of electrical turbine generators as additional regenerative braking. An additional renewable energy source for onboard generation includes semiconductor photovoltaic panels integrated into the vehicle construction. The high peak output generating methods such as braking and photovoltaics are set up to generate electricity to be stored in electrical storage capability including batteries, capacitors, or spinning fly wheel, where in such electricity storage is to be controlled by subsystem control software and algorithms for electrical and hydrogen energy flow management. Such electricity is directed for low voltage directly into the onboard photoelectrochemical or electrochemical hydrogen generator to disassociate water into hydrogen and oxygen. This self-contained on-site portable system for producing hydrogen provides hydrogen as an energy source for fuel cell electrical generation for all vehicle power. Any excess hydrogen generated onboard the vehicles may also be offloaded to storage and employed in fuel cells for electricity or for flame for internal combustion engines, ovens, furnaces, kilns, and steam engines. Such hydrogen is also available for other commercial uses such as for mobile vehicles of all types or for over the road tractor trailer refrigeration and air conditioning or for stationary refrigeration and air-conditioning. Both the wind and the solar generation capabilities of the equipment described here may also be employed on stationary hydrogen generation equipment, as well as on moving vehicles.

While particular preferred and alternative embodiments of the present invention have been disclosed, it will be appreciated that many various modifications and extensions of the above described technology may be implemented using the teaching of this invention. All such modifications and extensions are intended to be included within the true spirit and scope of the appended claims.

What is claimed is:

1. A hydrogen gas generation system for a mobile vehicle, comprising:
a hydrogen generator generating hydrogen gas using an electrolysis process;
a hydrogen storage tank receiving hydrogen gas from the hydrogen generator;
a vehicle propulsion system consuming hydrogen gas received from the hydrogen tank; and
an on-board electrical generator providing at least some of the electricity for the electrolysis process.

2. The hydrogen gas generation system according to claim 1, wherein the hydrogen generator further comprises a proton-passing membrane for trapping the hydrogen gas and keeping the hydrogen gas separated from oxygen.

3. The hydrogen gas generation system according to claim 1, wherein the hydrogen storage tank is a low-pressure hydrogen tank.

4. The hydrogen gas generation system according to claim 1, wherein the hydrogen storage tank is a low-pressure hydrogen tank operating below about 200 psi.

5. The hydrogen gas generation system according to claim 1, further including a high pressure hydrogen reserve tank coupled to the vehicle propulsion system.

6. The hydrogen gas generation system according to claim 1, further including a control system that selectively couples the high pressure reserve tank to the vehicle propulsion system when the hydrogen storage tank has an insufficient amount of hydrogen gas.

7. The hydrogen gas generation system according to claim 1, wherein the vehicle propulsion system further comprises a fuel cell system that consumes the hydrogen gas and generates electrical power for powering an electrical drive motor.

8. The hydrogen gas generation system according to claim 1, wherein the vehicle propulsion system further comprises a combustion engine that consumes the hydrogen gas and generates mechanical power for powering a drive train.

9. The hydrogen gas generation system according to claim 1, wherein the on-board electrical generator comprises a photovoltaic cell.

10. The hydrogen gas generation system according to claim 1, wherein the on-board electrical generator comprises an electrical generator acting as a regenerative braking device.

11. The hydrogen gas generation system according to claim 1, wherein the on-board electrical generator comprises a wind turbine.

12. The hydrogen gas generation system according to claim 11, further including a movable vent that selectively directs an air flow into the wind turbine.

13. The hydrogen gas generation system according to claim 1, further including a battery that is charged by the on-board electrical generator.

14. A hydrogen gas generation system for a mobile vehicle, comprising:
a hydrogen generator using an electrolysis process to generate hydrogen gas;
a first electrical generator providing electrical power for the electrolysis process;
a second electrical generator providing electrical power for the electrolysis process; and
wherein at least one of the electrical generators is arranged to be driven by the mobile vehicle's kinetic energy.

15. The hydrogen gas generation system according to claim 14, wherein the other one of the electrical generators is driven by a photovoltaic cell.

16. The hydrogen gas generation system according to claim 14, further including a controller that operates the steps of:
determining that the mobile vehicle is moving with an excess kinetic energy;
activating, responsive to the determination, the electrical generation driven by the mobile vehicle's kinetic energy.

17. The hydrogen gas generation system according to claim 16, wherein the activating step comprises moving a vent to direct air flow to a wind turbine.

18. The hydrogen gas generation system according to claim 16, wherein the activating step comprises activating a generator to generate electricity from the vehicle's drive train.

19. The hydrogen gas generation system according to claim 16, wherein the determining step comprises sensing that the mobile vehicle is braking.

20. A hydrogen powered vehicle, comprising:
a hydrogen generator generating hydrogen gas using an electrolysis process;
a low-pressure hydrogen storage tank receiving hydrogen gas from the hydrogen generator;
a high-pressure reserve storage tank;
a vehicle propulsion system consuming hydrogen gas received from one of the storage tanks, the propulsion system producing kinetic energy for the vehicle;
a photovoltaic cell providing at least some of the electricity for the electrolysis process; and
an electrical generator driven by the vehicle's excess kinetic energy, and providing at least some of the electricity for the electrolysis process.
